(19) United States
(12) Patent Application Publication
(10) Pub. No.: US 2026/0220447 A1
(43) Pub. Date: Jul. 30, 2026

(54) FEATURE ENCODING SYSTEM, FEATURE ENCODING METHOD, AND FEATURE ENCODING PROGRAM

(71) Applicant: Hitachi, Ltd., Tokyo (JP)

(72) Inventors: Ko ARAI, Tokyo (JP); Hiroaki AKUTSU, Tokyo (JP)

(21) Appl. No.: 19/460,441

(22) Filed: Jan. 27, 2026

(30) Foreign Application Priority Data
Jan. 28, 2025 (JP) 2025-011938

(51) Int. Cl. G06N 3/063; G06F 17/16; G06N 3/045

(52) U.S. Cl. CPC G06N 3/063; G06F 17/16; G06N 3/045

(57) ABSTRACT

A feature encoding system includes one or more neural network layer processors, and the neural network layer processors is configured to include a determination-type variable transformer that determines, for each of elements in an element group, whether the element has a large effect on accuracy of the feature on the basis of a value of the element, and transforms, for a first element having a small effect on the accuracy of the feature, a value thereof to a value with a first bit length shorter than an original bit length, and also transforms, for a second element having the large effect on the accuracy of the feature, a value thereof to a value with a second bit length longer than the first bit length, and a matrix multiplication processor that performs a matrix multiplication operation by using the element group transformed by the determination-type variable transformer.

### CROSS-REFERENCE TO RELATED APPLICATIONS

This application claims priority from Japanese Patent Application No. 2025-011938 filed January 28, 2025. The entire content of the priority application is incorporated herein by reference.

### BACKGROUND

The present disclosure relates to a technology for encoding a feature of data.

With the advancement of a LLM (Large Language Model), as a technology for improving output accuracy thereof, the use of RAG (Retrieval-Augmented Generation) has been progressing. When the RAG is to be constructed, features of data are encoded. In recent years, for feature encoding processing, neural networks have been used, and this has resulted in a problem of enormous processing time. This problem is particularly noticeable in a Multi-Modal RAG, which is constructed by encoding features from media data.

As a related technology, Japanese Patent Application Publication No. 2020-9048 discloses a technology of lightening a neural network by uniformly reducing bit lengths of numerical values to be operated by a neural network model.

### SUMMARY

As the bit lengths of numerical values, which are to be calculated by a neural network that performs feature encoding processing of data, are reduced, the processing time can be reduced. However, there may be a problem in that the quality of the encoded features may deteriorate thereby resulting in lower output accuracy when the RAG is used. Note that feature quality can be evaluated by using an evaluation score.

The present disclosure has been achieved in view of the circumstances described above, and an object thereof is to provide a technology that can reduce or prevent the quality deterioration of an encoded feature, while improving a processing speed of feature encoding of data by using a neural network.

To attain the above object, a feature encoding system according to an aspect is a feature encoding system that encodes a feature of data, and includes: one or more neural network layer processors, wherein at least one of the neural network layer processors includes: a transformation processor that determines, for each of elements in an element group to be used for an operation, whether or not the element has a large effect on accuracy of the feature of the data on the basis of a value of the element, transforms, for a first element having a small effect on the accuracy of the feature, a value thereof to a value with a first bit length shorter than an original bit length, and transforms, for a second element having the large effect on the accuracy of the feature, a value thereof to a value with a second bit length longer than the first bit length; and a matrix multiplication processor that performs a matrix multiplication operation by using the element group transformed by the transformation processor.

According to the present disclosure, it is possible to reduce or prevent the quality deterioration of an encoded feature, while improving a processing speed of feature encoding of data by using a neural network.

### BRIEF DESCRIPTION OF THE DRAWINGS

FIG. 1 is an overall configuration diagram of a computer system according to an embodiment;

FIG. 2 is an illustrative view of feature encoding processing according to the embodiment;

FIG. 3 is an illustrative view of a feature encoder according to the embodiment;

FIG. 4 is an illustrative view of a determination-type variable transformer according the embodiment;

FIG. 5 is an illustrative view of a determinator according to the embodiment;

FIG. 6 is a flow chart of feature encoder construction processing according to the embodiment;

FIG. 7 is an illustrative view of a first method for processing of determining a bit length and a to-be-allocated element count according to the embodiment; and

FIG. 8 is an illustrative view of a second method for the processing of determining the bit length and the to-be-allocated element count according to the embodiment.

### DETAILED DESCRIPTION OF THE EMBODIMENT

Referring to the drawings, a description will be given of embodiments. It should be noted that the embodiments described below are not intended to limit the invention according to the claims, and all of the elements and combinations thereof described in the embodiments are not necessarily essential to the solution of the invention.

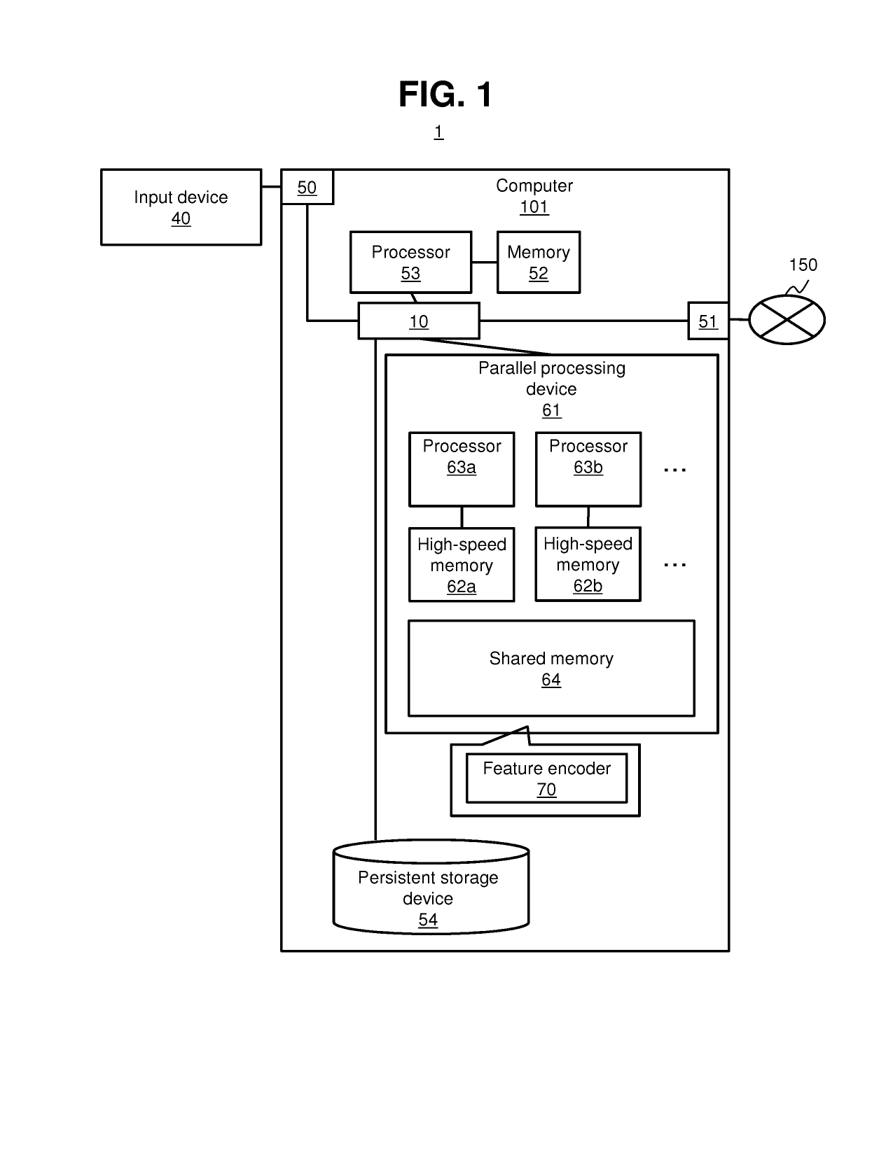

FIG. 1 is an overall configuration diagram of a computer system according to an embodiment.

A computer system 1 has an input device 40 and a computer 101. The computer 101 is an example of a feature encoding system. It can also be said that the computer system 1 is an example of the feature encoding system. In FIG. 1, an example in which the feature encoding system is configured to include the one computer 101 is shown, but the feature encoding system may also be configured to include a plurality of the computers. The computer 101 may also be coupled to a network 150. The network 150 is a communication path such as, e.g., a wired LAN (Local Area Network), a wireless LAN, a WAN (Wide Area Network), or a dedicated line. The computer 101 is coupled to the input device 40.

The input device 40 is configured of a computer such as, e.g., a PC (Personal Computer), receives an input from a user, and performs various processing by using data. The input device 40 stores data to be used for processing in the computer 101, and acquires the data to be used for processing from the computer 101. Note that the input device 40 may also be a virtual calculation resource (such as, e.g., a virtual machine or container) in a cloud environment. Alternatively, the input device 40 may also be, e.g., a mouse, a keyboard, or the like and, in that case, the computer 101 may perform processing other than a function input thereto.

The computer 101 stores and manages data to be used in the input device 40. The computer 101 performs processing of encoding a feature of data (feature encoding processing). The computer 101 is configured of a computer such as, e.g., a PC or a server device, and includes a processor 53, a memory 52, IFs (interfaces) 50 and 51, a parallel processing device 61, a persistent storage device 54, and a bus 10 connecting these components. Note that the computer 101 may also be a virtual calculation resource (such as, e.g., a virtual machine or container) in a cloud environment.

The IFs 50 and 51 are interfaces such as, e.g., wired LAN cards or wireless LAN cards, and communicate with another device via the network 150 or a communication line.

The processor 53 is an example of a main processor, and performs various processing according to programs stored in the memory 52.

The memory 52 is, e.g., a RAM (Random Access Memory), and stores the programs to be executed by the processors 53 and required information.

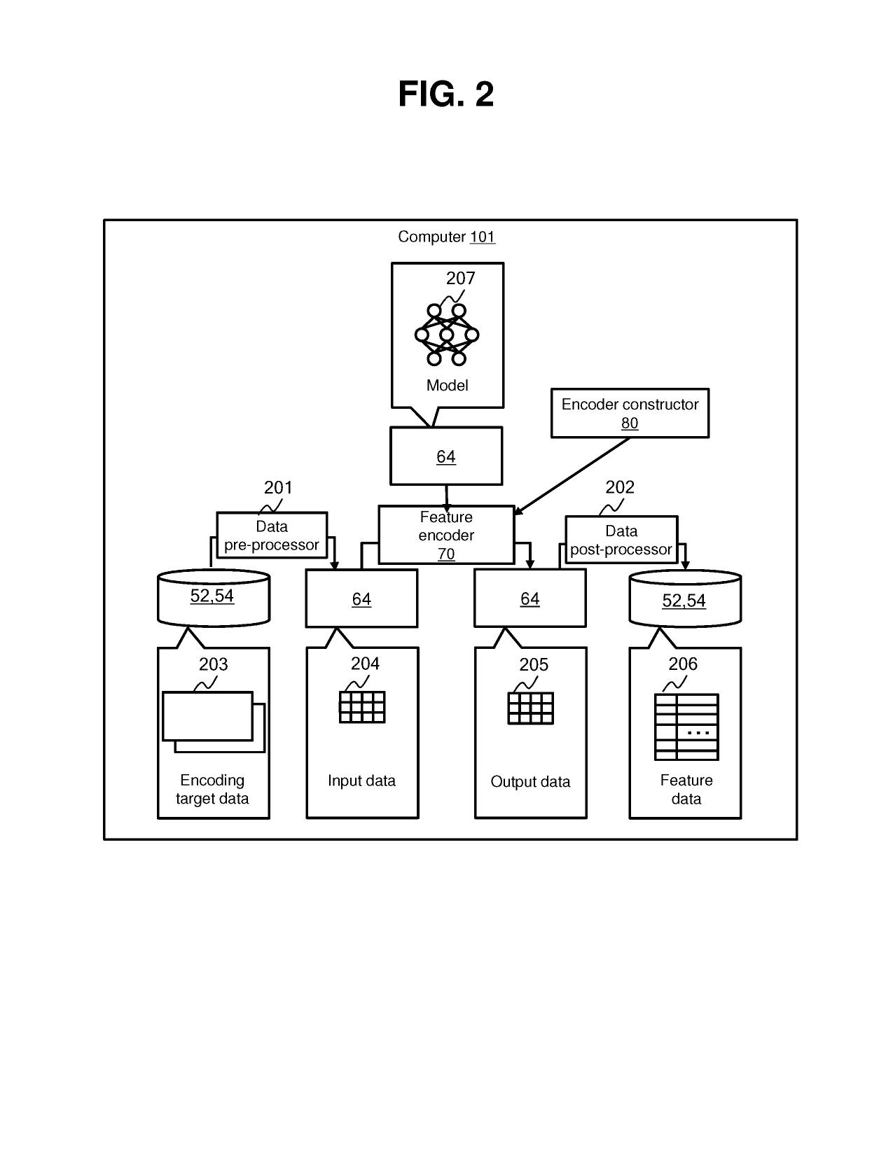

The persistent storage device 54 is, e.g., a hard disk, a flash memory, or the like, and stores the program read into the memory 52 to be implemented in the processor 53, various data to be used by the processor 53, a program to be implemented by processors 63 (63a and 63b) of the parallel processing device 61, and various data to be used by the processors 63. In the present embodiment, the persistent storage device 54 stores a feature encoding program for performing the feature encoding processing as a program, and stores encoding target data 203 (see FIG. 2) as data. Note that, instead of or in addition to the persistent storage device 54, a storage on a cloud connected via the network 150 may also be used. Note that the persistent storage device 54 and the storage on the cloud may also be formed of a block storage, a file storage, an object storage, a database, and the like.

The parallel processing device 61 is a device capable of performing processing in parallel, such as, e.g., a GPU (Graphics Processing Unit), an ASIC (Application specific integrated circuit), an FPGA (Field Programmable Gate Array), a multi-core CPU (Central Processing Unit), or the like. The parallel processing device 61 includes a plurality of high-speed memories 62a, 62b, and the like (which may be denoted simply by 62), a plurality of processors 63a, 63b, and the like (which may be denoted simply by 63), and a shared memory 64. The processors 63 perform processing according to a program stored in the shared memory 64. The high-speed memories 62 and the shared memory 64 are examples of a storage unit, and store the programs to be executed by the processors 63, and data to be used by the processors 63. The high-speed memories 62 are provided correspondingly to, e.g., the individual processors 63. The high-speed memories 62 are generally high in speed, but low in capacity. The high-speed memories 62 can be accessed faster than the shared memory 64. The plurality of processors 63 can perform various processing in parallel by using the high-speed memories 62 and the shared memory 64. In the present embodiment, the parallel processing device 61 constitutes a feature encoder 70 by performing a program. Note that at least some of components of the feature encoder 70 may also be configured of the processor 53 and the memory 52.

Next, a description will be given of a general outline of the feature encoding processing in the computer system 1.

FIG. 2 is an illustrative view of the feature encoding processing according to the embodiment.

The description will be given on the assumption that, in the feature encoding processing, data to be subjected to encoding (encoding target data) is stored in advance in the memory 52 or the persistent storage device 54 of the computer 101.

A data pre-processor 201 of the computer 101 acquires the encoding target data 203 from the memory 52 or the persistent storage device 54. The encoding target data 203 is, e.g., image data. The data pre-processor 201 performs transformation processing of transforming the encoding target data 203 to input data 204 to be input to the feature encoder 70. The data pre-processor 201 is configured by the one or more processors 63 of the parallel processing device 61 by executing the program in the shared memory 64. For example, the data pre-processor 201 transforms the encoding target data 203 of B batches to be encoded in parallel, i.e., B image data sets to the input data 204 (a tensor of, e.g., the number of batches (B) × the number of colors (C) × the number of vertical pixels (V) × the number of lateral pixels (H)), and stores the input data 204 in the shared memory 64. The data pre-processor 201 may also perform decoding processing according to a format of the encoding target data (e.g., JPEG (Joint Photographic Experts Group) or PNG (Portable Network Graphics)).

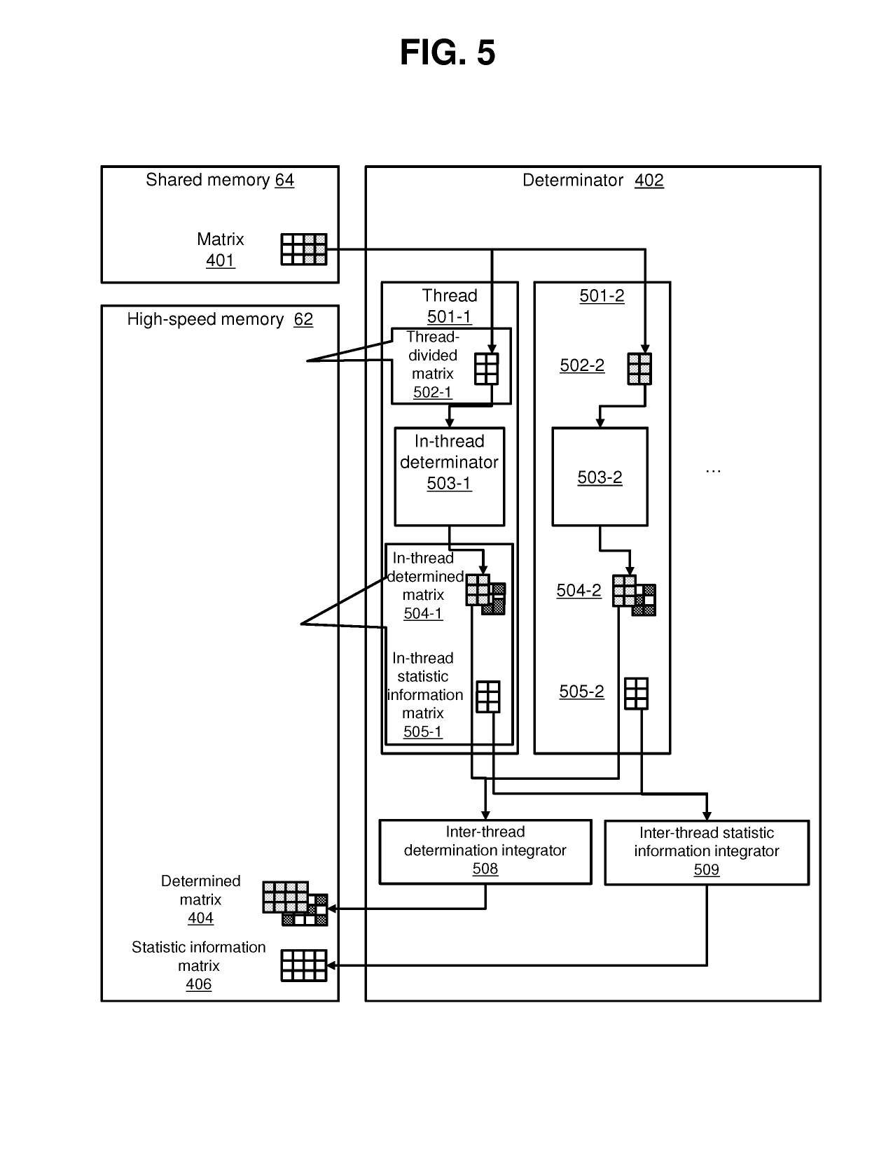

The feature encoder 70 performs the feature encoding processing on the input data 204 to thereby perform transformation processing of transforming the input data 204 to the output data 205 (a tensor of, e.g., he number of batches (B) × the feature vector dimension (D)), and stores the output data 205 in the shared memory 64. The feature encoder 70 is configured by, e.g., the one or more processors 63 of the parallel processing device 61 by executing the program in the shared memory 64. The feature encoder 70 is constructed on the basis of a model 207, the details of which will be described with reference to FIG. 5.

Then, a data post-processor 202 performs transformation processing of transforming the output data 205 to feature data 206, and stores the feature data 206 in the memory 52 or the persistent storage device 54. For example, the data post-processor 202 may also transform, for the feature data 206, tensor-type data to a one-dimensional array or reduce an amount of data by pooling processing. The data post-processor 202 is configured by, e.g., the processors 63 of the parallel processing device 61 by executing the program in the shared memory 64.

Next, a description will be given of a configuration and processing of the feature encoder 70.

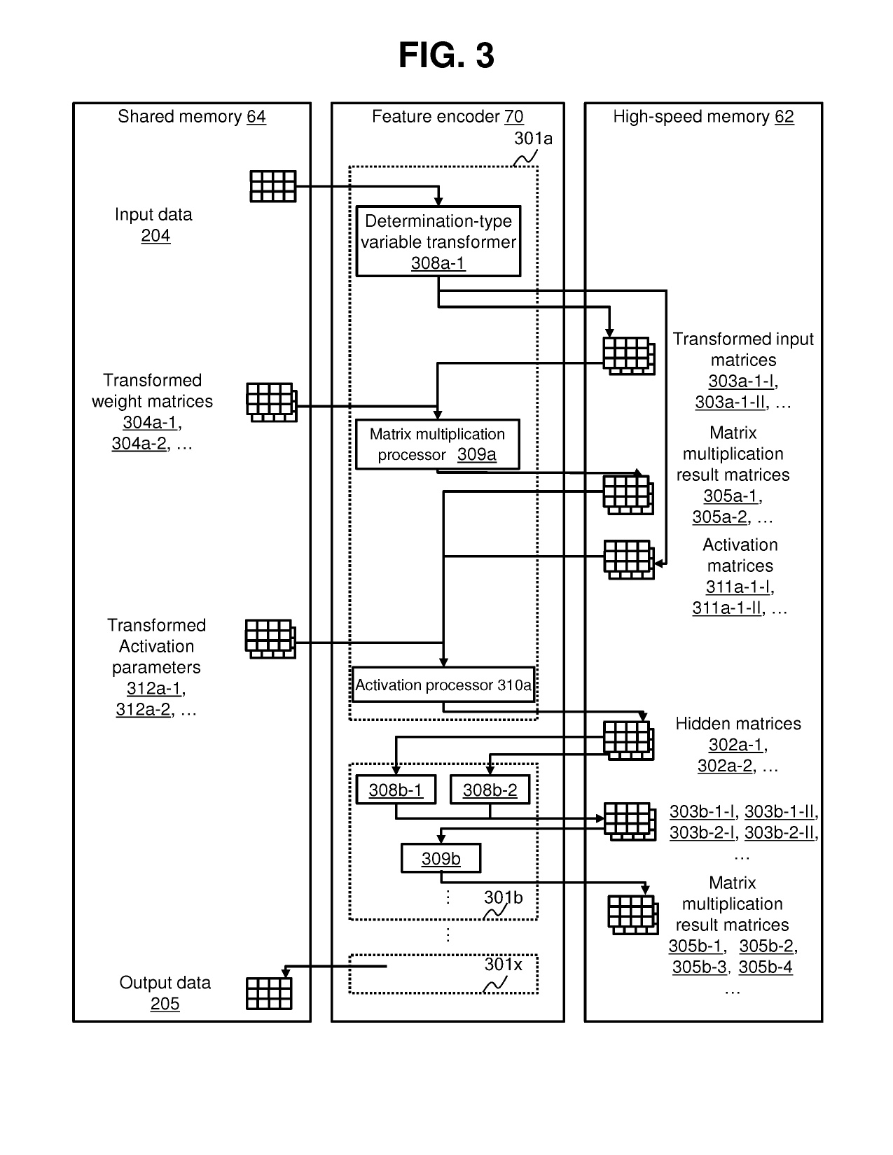

FIG. 3 is an illustrative view of the feature encoder according to the embodiment.

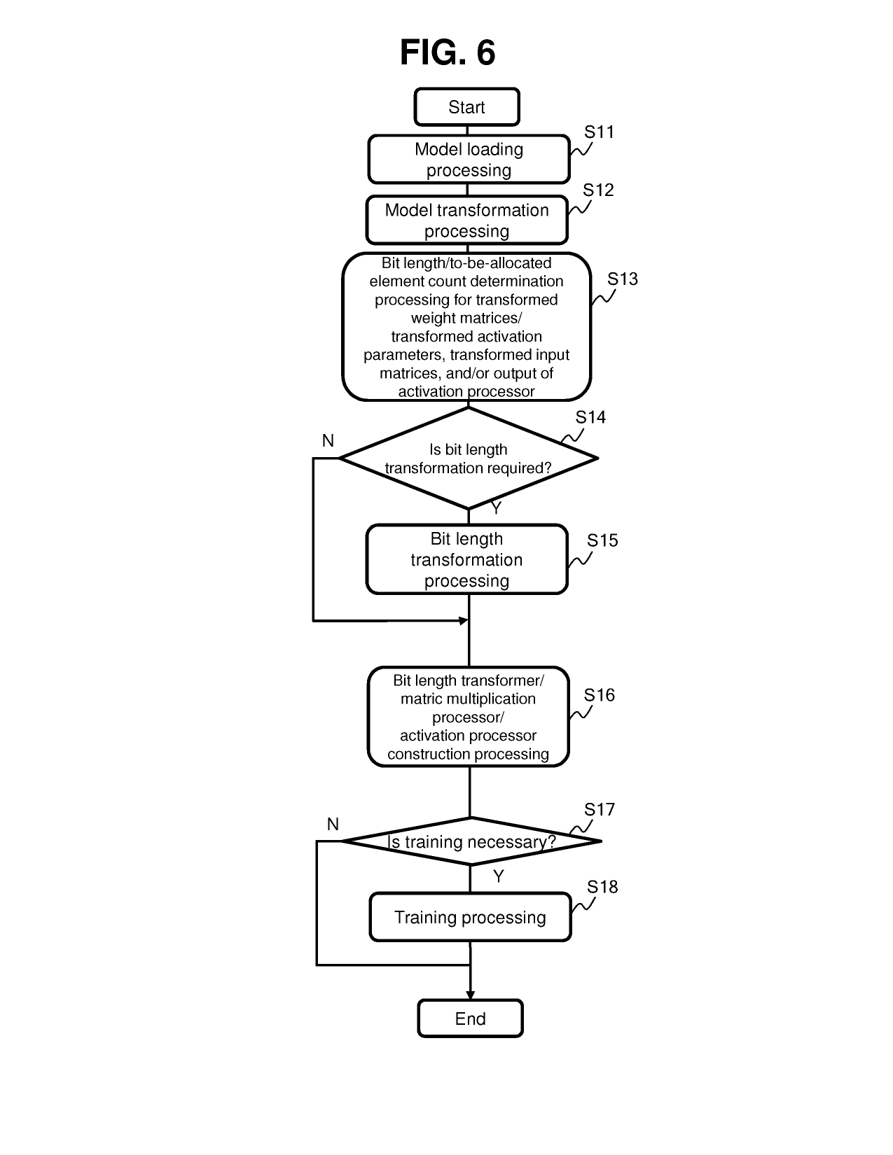

The feature encoder 70 has one or more neural network layer processors 301a, 301b, ..., 301x, and the like (which may be denoted simply by 301). The neural network layer processors 301 are configured by, e.g., the processors 63 of the parallel processing device 61 by executing the program in the shared memory 64. The neural network layer processor 301 is configured by performing model transformation processing (FIG. 6: S12) and the like described later. The neural network layer processor 301 may be configured so as to perform, e.g., linear transformation layer processing, convolutional neural network layer processing, transformer layer processing, or processing corresponding to a portion thereof.

Each of the neural network layer processors 301 receives an input of one or more matrices, and outputs one or more matrices. The matrices output from the neural network layer processor 301 may be, hidden matrices 302 (302a-1 and 302a-2) like from the neural network layer processor 301a, or may also be the output data 205 like from the neural network layer processor 301x. The matrices input to the neural network layer processor 301 may be the input data 204 like to the neural network layer processor 301a, or may also be the hidden matrix 302 output from the other neural network layer processor 301a like to the neural network layer processor 301b. The neural network layer processor 301 includes one or more determination-type variable transformers 308 (such as, e.g., 308a-1: transformation processor), a matrix multiplication processor 309 (e.g., 309a), and an activation processor 310 (e.g., 310a).

The determination-type variable transformer 308 receives an input of a matrix, and outputs one or more transformed input matrices 303 (such as the transformed input matrices 303a-1-I and 303a-1-II). The determination-type variable transformer 308 may also further output one or more activation matrices 311 (such as the activation matrices 311a-1-I and 311a-1-II).

The transformed input matrices 303 is a matrix in which each of elements of the matrix input to the determination-type variable transformer 308 (which may be referred to also as the input matrix) is represented by a numerical value of the bit length of each of the elements of the input matrix or less. While the example in which the determination-type variable transformer 308 outputs the transformed input matrix 303 in a matrix format is described, the transformed input matrix 303 may also be a data structure including sets of indices and values, not in the matrix format. For example, when each of the elements of the input matrix is represented by a 16-bit floating-point number, the transformed input matrix 303 may also be two matrices which are a matrix in which each of elements is represented by a 4-bit signed integer and a matrix in which each of elements is represented by a 8-bit signed integer. Each of the activation matrices 311 is a matrix including information required by the activation processor 310. For example, the activation matrix 311 may also be a matrix including per-row average values in the input matrix, a maximum value of per-row absolute values therein, or both thereof.

The matrix multiplication processor 309 receives an input of the one or more transformed input matrices 303 and zero or more transformed weight matrices 304 to perform a matrix multiplication operation, or receives an input of the two or more transformed input matrices 303 without receiving an input of the transformed weight matrices 304 to perform the matrix multiplication operation, or alternatively receives an input of the one transformed weight matrix 304 and the one or more transformed input matrices 303 to perform the matrix multiplication operation, and outputs matrix multiplication result matrices 305 (such as the matrix multiplication result matrices 305a-1 and 305a-2), which are results of the matrix multiplication operations. The matrix multiplication operations performed in the matrix multiplication processor 309 may also be a batching matrix multiplication operation in which a plurality of matrix multiplication operations are collectively performed. Here, each of the transformed weight matrices 304 is a weight matrix obtained by transforming the weight of an initial bit length prepared as a model to match a bit length reduction, which is stored in the shared memory 64.

For example, the matrix multiplication processor 309a of the neural network layer processor 301a receives an input of the transformed input matrices 303a-1-I and 303a-1-II and the transformed weight matrix 304a-1, performs a matrix multiplication operation between the transformed input matrix 303a-1-I and the transformed weight matrix 304a-1 to output the matrix multiplication result matrix 305a-1, and performs a matrix multiplication operation between the transformed input matrix 303a-1-II and the transformed weight matrix 304a-1 to output the matrix multiplication result matrix 305a-2. Meanwhile, the matrix multiplication processor 309b of the neural network layer processor 301b receives an input of the transformed input matrices 303b-1-I, 303b-1-II, 303b-2-I, and 303b-2-II, performs a matrix multiplication operation between the transformed input matrices 303b-1-I and 303b-2-I to output the matrix multiplication result matrix 305b-1, performs a matrix multiplication operation between the transformed input matrices 303b-1-I and 303b-2-II to output the matrix multiplication result matrix 305b-2, performs a matrix multiplication operation between the transformed input matrices 303b-1-II and 303b-2-I to output the matrix multiplication result matrix 305b-3, and performs a matrix multiplication operation between the transformed input matrices 303b-1-II and 303b-2-II to output a matrix multiplication result matrix 305b-4. Note that, when at least one of the transformed input matrices 303 and the transformed weight matrix 304 is sparse matrix, the matrix multiplication processor 309 may also perform matrix multiplication operations on only elements having values other than 0 without performing matrix multiplication operations on all the elements, and thereby reduce processing time.

By providing a configuration as described above, the neural network layer processor 301 can implement various neural network models such as a convolutional neural network model and a transformer network model. Meanwhile, the matrix multiplication processor 309, which performs the matrix multiplication operations between the plurality of pairs of matrices, may also perform such processing in parallel by using different cores of the processors 63, or may also continuously perform the processing by using the same core.

The activation processor 310 receives an input of the one or more matrix multiplication result matrices 305, the zero or more activation matrices 311, and zero or more activation parameters 312 (such as the activation parameters 312a-1 and 312a-2), and performs activation function processing to output one or more matrices. The activation function processing may also be, e.g., GeLU function processing (Gaussian Error Linear Unit), softmax function processing, or identity function processing. The activation processor 310 may also take sums of the matrix multiplication result matrices 305 and a predetermined matrix (e.g., the input data 204 to the shared memory 64), and then perform the activation function processing. The activation parameters 312 may also be a bias term in a linear layer, a temperature parameter in the softmax function processing, a scale value (the multiple used in the case of transformation to an integer after performing multiplication by a predetermined multiple when the bit length is reduced) used for the transformed weight matrix 304, and the like. Alternatively, it may also be possible to take respective products of the plurality of matrix multiplication result matrices 305 and the activation matrices 311, take sums of the results thereof, and then perform the activation function processing. In addition, bit lengths representing the individual elements of the matrix output by the activation processor 310 may also be different from bit lengths representing respective elements of the input data 204 and the output data 205. The activation processor 310 may also output a plurality of matrices represented by different bit lengths, like the transformed input matrices 303. For example, when the input data 204 and the output data 205 are represented by 16-bit floating-point numbers, the activation processor 310 may also output a matrix in which each of elements is represented by a 4-bit signed integer and a matrix in which each of elements is represented by an 8-bit signed integer.

By dividing the transformed input matrices 303, the matrix multiplication result matrices 305, the activation matrices 311, and the hidden matrices 302 into matrix areas, which are areas to be processed by the individual processors 63 and storing the matrix areas resulting from the division in the high-speed memories 62, it is possible to increase the speed of processing in the neural network layer processors 301. Note that the processing speed is increased by storing the transformed input matrices 303, the matrix multiplication result matrices 305 (intermediate result), the activation matrices 311 (intermediate result), and the hidden matrices 302 in the high-speed memories 62, but it may also be possible to store at least some of these in the shared memory 64. Moreover, with regard to the processing included in the determination-type variable transformers 308, the matrix multiplication processors 309, and the activation processor 310, it may also be possible to combine the input matrices or change an execution order without affecting an operation result. Furthermore, the combining of the input matrices and the changing of the execution order may also be performed across the plurality of neural network layer processors 301.

For example, with regard to matrix multiplication processing of generating a query, matrix multiplication processing of generating a key, and matrix multiplication processing of generating a value in a transformer network, it may be possible to construct the different neural network layer processors 301 to provide the total of three neural network layer processors 301, or combine the transformed weight matrices 304 together, collectively perform the processing in the determination-type variable transformers 308, the matrix multiplication processors 309, and the activation processor 310 in sequence without implementing the three neural network layer processors 301 in succession, and thereby construct the one neural network layer processor 301. In addition, when, e.g., attention processing is to be performed by the neural network layer processors 301, it may also be possible to change execution order such that the matrix multiplication processors 309 and the activation processor 310 are implemented in the order shown by Flash Attention 2. By thus changing the execution order, it is possible to further increase the speed of the processing in the neural network layer processor 301.

Next, a description will be given of a configuration of and processing in the determination-type variable transformers 308.

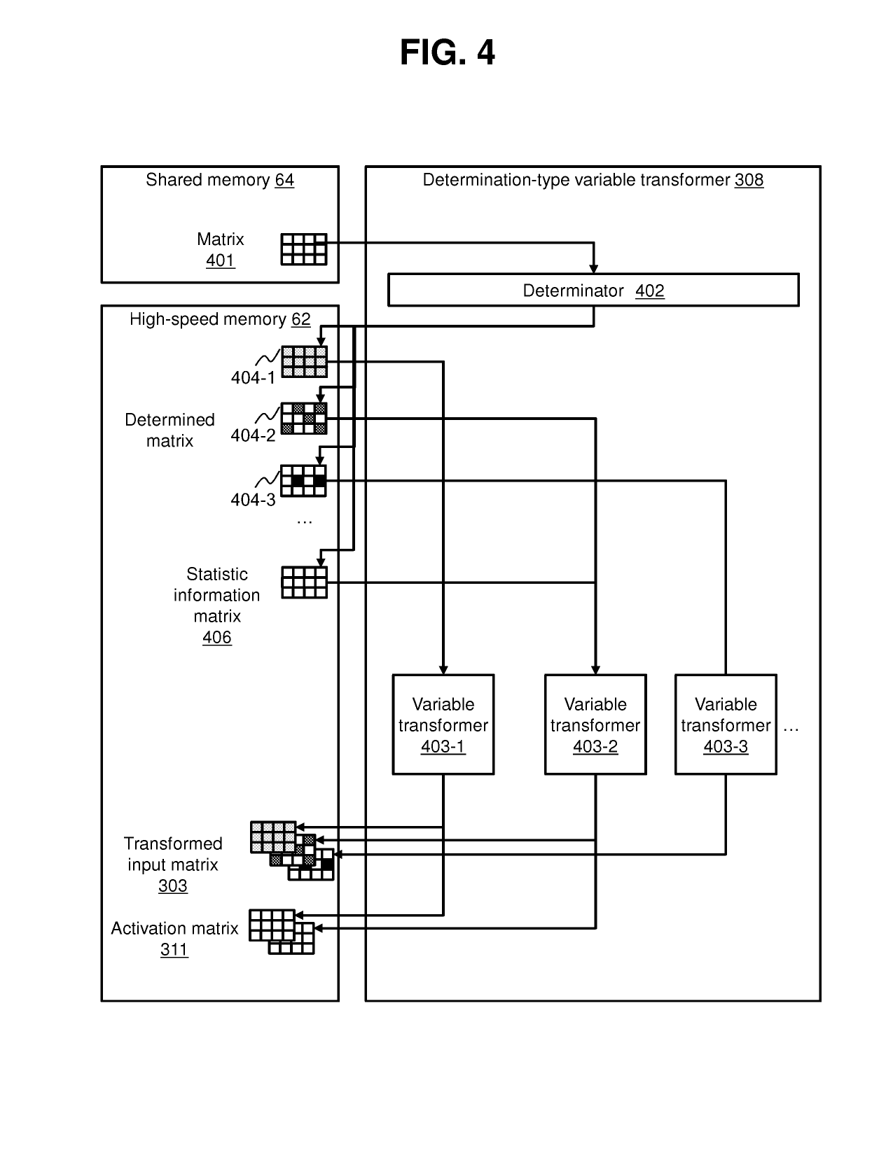

FIG. 4 is an illustrative view of the determination-type variable transformers according to the embodiment.

The determination-type variable transformer 308 includes a determinator 402 and one or more variable transformers 403 (such as 403-1 and 403-2). The determinator 402 and the variable transformers 403 are configured by the one or more processors 63 of the parallel processing device 61 by executing the program in the shared memory 64.

The determinator 402 receives an input of a matrix 401 (element group), calculates, on the basis of a value (e.g., absolute value) of each of elements of the matrix 401, a determination value indicating whether or not each of the elements is an element (second element) having a large effect on the accuracy (quality) of a feature, and outputs, on the basis of a determination value, one or more determined matrices 404 (such as 404-1 and 404-2) and a statistic information matrix 406 to the high-speed memories 62. The matrix 401 may also be, e.g., the input data 204, the hidden matrices 302, or a weight matrix described later.

The determinator 402 may also calculate, for, e.g., each of the elements of the matrix 401, an absolute error from each of per-row average values in the matrix 401 (the number of the elements in each row is, e.g., 1152), and determine that each of the elements (second elements) ranked in the top predetermined number (e.g., 32 or a number corresponding to a predetermined percentage (e.g., 5%) or less of the number of the elements in the row) in terms of the large effect on the accuracy of a feature in each row (the large absolute error) has a determination value of 2 indicating the large effect, while determining that each of the elements (first elements) not ranked in the top predetermined number has a determination value of 1 indicating the small effect. Alternatively, the determinator 402 may also calculate an absolute value for each of the elements of the matrix 401, divide the rows therein into groups of a predetermined number of rows (e.g., 8 rows), calculate, for each column, a sum of the absolute values of the group of the predetermined number of rows, and determine that each of the elements belonging to the columns ranked in the top predetermined number in descending order of value has the determination value of 2, while determining that each of the elements not corresponding to the top predetermined number described above has the determination value of 1. Since the number of the elements each determined to have the large effect is limited to the predetermined number or less, it is possible to suppress an effect on a bit length reduction. For example, as an algorithm for selecting the top predetermined number of elements, a high-speed selection algorithm described later with reference to FIG. 5 may also be adopted. It may also be possible to associate a plurality of determination values with one element. For example, it may also be possible to calculate, for each of the elements of the matrix 401, an absolute error from a per-row average value in the matrix 401, and determine that each of the top predetermined number of elements in each row has the determination values of 1 and 2 indicating the large effect on the accuracy of the feature, while determining that each of the elements not corresponding to the top predetermined number has the determination value of 1 indicating the small effect. Note that the determinator 402 may further calculate another determination value (e.g., a determination value of 3) for some of the top predetermined number of elements which are rather highly ranked.

The statistic information matrix 406 is the matrix that stores statistic information required for processing in the variable transformer 403. The determinator 402 may also output the matrix that stores the per-row average values and the per-row absolute maximum values in the matrix 401 as the statistic information matrix 406 to the high-speed memories 62. Note that, for the determination value of 3 mentioned above, the bit length is not reduced in subsequent processing, and therefore the statistic information matrix 406 need not be output.

The determined matrices 404 are the matrices that store values based on the elements determined to have the same determination value. The determined matrices 404 need not be in a matrix format, and may also be a data structure including sets of indices and values of the matrix 401. The determinator 402 outputs the determined matrices 404 corresponding to the number of the determination values that can be calculated to the high-speed memories 62. For example, when the determination values are calculated as three values, the determinator 402 outputs the three determined matrices 404 (404-1, 404-2, and 404-3) based on the elements corresponding to the respective determination values. For example, the determinator 402 outputs the determined matrices 404 in which only the individual elements corresponding to the respective determination values in the matrix 401 are left to retain original values, while each of the other elements is provided with 0. Note that each of the elements of the determined matrices 404 need not be identical to each of the elements of the matrix 401. For example, each of the elements of the determined matrix 404 may also have a value obtained by subtracting the per-row average value in the matrix 401 from the value of each of the elements of the matrix 401. Thus, it is possible to reduce a processing load in the variable transformers 403.

For example, when the determination values of 1 and 2 are used in the case of indicating the large effect on the accuracy of the feature and the determination value of 1 is used in the case of indicating the small effect, the determinator 402 outputs the determined matrix 404-1 in which the elements (which are all the elements in the present embodiment) each determined to have the determination value 1 are left as-is. In addition, the determinator 402 outputs the determined matrix 404-2 which has the same matrix size as that of the matrix 401 and in which each of the elements determined to have the determination value 2 is provided with the value of the element in the matrix 401 (or a value corresponding to the difference between the value and a value that can be represented when the bit length of each of the elements of the determined matrix 404-1 is reduced), while each of the other elements is provided with 1.

The variable transformers 403 receive inputs of the determined matrices 404 produced on the basis of the elements determined to have the predetermined determination values, and further receive the statistic information matrix 406 corresponding to the predetermined determination values if there is, performs bit length reduction processing of transforming each of the elements of the determined matrices 404 to an element represented with a bit length (first bit length or second bit length) shorter than the bit lengths of the elements of the determined matrices 404, and outputs the transformed input matrices 303 including the elements as a processing result to the high-speed memories 62, while outputting the corresponding activation matrices 311 to the high-speed memories 62. Note that, in the case where only the determined matrix 404-3 is input in the same manner as to the variable transformer 403-3, the input matrix is output directly as the transformed input matrix 303, and the activation matrix 311 need not be output. The variable transformers 403 corresponding to the number of the determination values that can be calculated are constructed.

For example, when the determination values are calculated as two values, the two variable transformers 403 are constructed. The bit length reduction processing in each of the variable transformers 403 may also be, e.g., processing in which, in the case of bit length reduction to a signed 4-bit integer, for each of the elements of the determined matrices 404 to be subjected to the transformation, the per-row average value in the matrix 401 stored in the statistic information matrix 406 is subtracted from the value of the element, the resulting value is divided by the per-row maximum value in the matrix 401 stored in the statistic information matrix 406, the resulting value is multiplied by 7 and then transformed to a closest integral value to thus transform the value of the element to the signed 4-bit integer. This processing can prevent the value from overflowing by performing the processing of dividing the value of the element by the maximum value. Alternatively, the bit length reduction processing in the variable transformer 403 may also be processing in which, e.g., for each of the elements of the determined matrices 404, the per-row average value in the matrix 401 stored in the statistic information matrix 406 is subtracted from the value of the element, the sign thereof is used as a first-order bit, subsequently a product of the per-row absolute average value in the matrix 401 stored in the statistic information matrix 406 and the sign is subtracted from the value of the element, and the sign thereof is used as a second-order bit to thus transform the value of the element to a 2-bit encoded numerical value. Note that FIG. 4 illustrates an example in which the determined matrices 404 and the statistic information matrix 406 are stored in the high-speed memories 62, but the determined matrices 404 and the statistic information matrix 406 may also be stored in the shared memory 64.

Thus, the determination-type variable transformers 308 represent the element having the small effect on the accuracy of the feature with a shorter bit length, and therefore it is possible to increase the speed of the processing in the neural network layer processors 301, while representing the element having the large effect on the accuracy of the feature with a bit length longer than the bit length of the element having the small effect, and therefore it is possible to prevent deterioration of the accuracy of the feature.

Next, a description will be given of a configuration of and processing in the determinator 402.

FIG. 5 is an illustrative view of the determinator 402 according to the embodiment.

The parallel processing device 61 divides the processing by using a plurality of threads 501 and performs the divided processing. The parallel processing device 61 has the determinator 402 shown in FIG. 5. The determinator 402 includes the plurality of threads 501 (such as 501-1 and 501-2), an inter-thread determination integrator 508, and an inter-thread statistic information integrator 509. The inter-thread determination integrator 508 and the inter-thread statistic information integrator 509 are configured by the one or more processors 63 by executing the program in the shared memory 64.

Into the threads 501 (501-1 and 501-2) of the determinator 402, thread-divided matrices 502 (502-1 and 502-2) obtained by dividing the matrix 401 into predetermined units are loaded. In-thread determinators 503 (such as 503-1 and 503-2: preliminary determines) perform preliminary processing of calculating, for the thread-divided matrices 502, determination values (in-thread determination values) indicating whether or not each of the elements is the element having the large effect on the accuracy of the feature in the threads on the basis of the value of each of the values, generate in-thread determined matrices 504 (such as 504-1 and 504-2) corresponding to the in-thread determination values as well as in-thread statistic information matrices 505 (such as 505-1 and 505-2), and output the in-thread determined matrices 504 and the in-thread statistic information matrices 505 to the high-speed memories 62.

For example, the in-thread determinators 503 determine that, among the individual elements of the thread-divided matrices 502, those ranked in the top 4 in terms of the absolute error from the per-row average value have in-thread determination values of 1 and 2, while determining that each of the other elements of the thread-divided matrices 502 has an in-thread determination value of 1, generate the in-thread determined matrices 504 corresponding to the respective in-thread determination values, and generate the per-row average values in the thread-divided matrices 502 and a maximum value of the absolute errors from the per-row average values as the in-thread statistic information matrices 505.

The inter-thread determination integrator 508 receives an input of the plurality of in-thread determined matrices 504 (determination result), calculates the determination value indicating whether or not each of the elements of the matrix 401 is the element having the large effect on the accuracy of the feature, and outputs the determined matrix 404 corresponding to the determination value. For example, the inter-thread determination integrator 508 determines that, in the plurality of in-thread determined matrices 504, among the elements determined to have the in-thread determination value of 2, each of the elements ranked in the top 32 in terms of the absolute error from the per-row average value has the determination values of 1 and 2 indicating the element having the large effect on the accuracy of the feature, while determining that each of the other elements has the determination value of 1 indicating the element having the small effect on the accuracy of the feature.

The inter-thread statistic information integrator 509 receives an input of the plurality of in-thread statistic information matrices 505, and generates the statistic information matrix 406 to be used in the variable transformers 403 to output the statistic information matrix 406. For example, the inter-thread statistic information integrator 509 acquires, from the plurality of in-thread statistic information matrices 505, per-row average values in the respective thread-divided matrices 502, takes the average thereof to calculate the per-row average values in the matrix 401, and stores the statistic information matrix 406. In addition, the inter-thread statistic information integrator 509 acquires, from the plurality of in-thread statistic information matrices 505, maximum values of the absolute errors from the per-row average values in the respective thread-divided matrices 502, compares these to each other to calculate a maximum value of the absolute errors from the per-row average values in the matrix 401, and stores the maximum value in the statistic information matrix 406. Note that FIG. 5 shows an example in which the thread-divided matrices 502, the in-thread determined matrices 504, and the in-thread statistic information matrices 505 are stored in the high-speed memories 62, but the thread-divided matrices 502, the in-thread determined matrices 504, and the in-thread statistic information matrices 505 may also be stored in the shared memory 64.

By thus performing two-stage processing in which preliminary processing is performed in advance on the in-thread determination values, the statistic information, and the like in each of the threads, and then processing of eventually integrating the determination values and the statistic information between the plurality of threads is performed, it is possible to minimize communication between the threads 501, increase a degree of parallelism, and increase the speed of the processing in the determinator 402.

Next, a description will be given of feature encoder construction processing of constructing the feature encoder 70.

FIG. 6 is a flow chart of the feature encoder construction processing according to the embodiment. The feature encoder construction processing is performed by an encoder constructor 80. The encoder constructor 80 can be implemented by, e.g., the one or more processor 63 and the shared memory 64.

The encoder constructor 80 first performs model loading processing of loading a model for encoding a feature of target data (S11). The model includes a weight matrix, activation parameters, and a graph relationship about matrix inputs and outputs in the neural network layer. The model may be, e.g., a known model provided by an external device.

Then, the encoder constructor 80 performs model transformation processing (S12). In the model transformation processing, e.g., the loaded model is transformed such that the one or more neural network layer processors 301 and a transformer provided by an external library continuously perform the processing. For example, when a transformer network is loaded as the model, transformation may also be performed such that the neural network layer processors 301 perform matrix multiplication processing of generating the query included in the model, matrix multiplication processing of generating a key, matrix multiplication processing of generating a value, matrix multiplication processing of generating Multi-head Attention, fully connected layer processing included in a feed-forward network, processing of calculating the product of the query and the key, and matrix multiplication processing of generating attention, while the transformer provided by the external library perform the other portions.

Then, the encoder constructor 80 performs, on each of the neural network layer processors 301, bit length/to-be-allocated element count determination processing of determining the bit length of each of the determination values and the number of elements (element count) to be allocated to each of the determination values on at least any one of the transformed weight matrices 304, the transformed activation parameters 312, the transformed input matrices 303, and the matrix output from the activation processor 310 (S13).

In the bit length/to-be-allocated element count determination processing, it may be possible to determine that, in the neural network layer processor 301 corresponding to transformer network processing performed first and the neural network layer processor 301 corresponding to transformer network processing when, e.g., the input data 204 is statically transformed to the output data 205 and in the neural network layer processor 301 corresponding to transformer network processing, a determination value is one and the bit length at the one determination value is 16 and all the elements are allocated to the determination value of 1. Meanwhile, it may be possible to determine that, in each of the neural network layer processors 301 not corresponding thereto, for the transformed weight matrices 304, a determination value is one and the bit length at the one determination value is 4 and all the elements are allocated to the determination value of 1, for the transformed activation parameters 312, a determination value is one and the bit length at the one determination value is 16 and all the elements are allocated to the determination value of 1, for the transformed input matrices 303, determination values are two and the bit lengths at the two determination values are 4 and 8 and all the elements are allocated to the determination value of 1, while 32 elements per row are allocated to the determination value of 2 and, for the matrix output from the activation processor 310, a determination value is one and the bit length at the one determination value is 16 and all the elements are allocated to the determination value of 1.

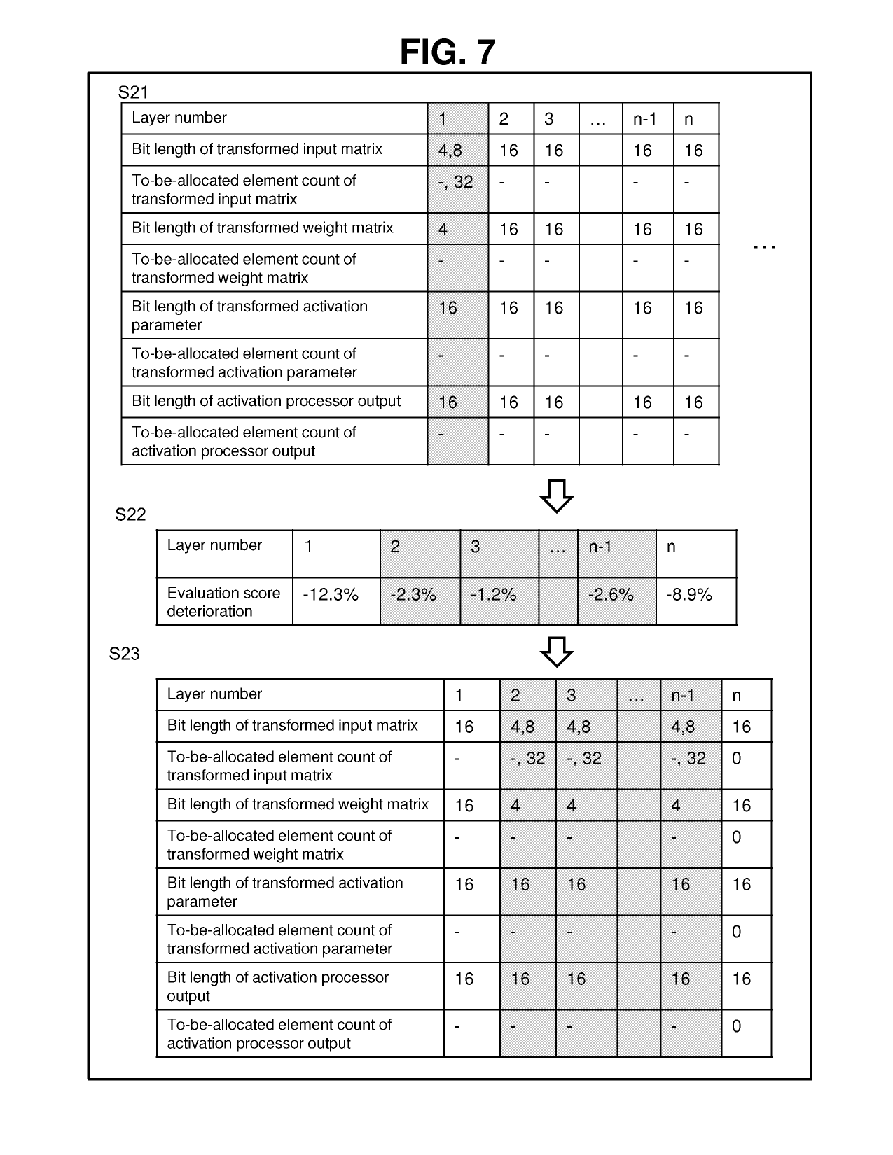

In addition, in the bit length/to-be-allocated element count determination processing, as shown in, e.g., FIG. 7, the encoder constructor 80 performs bit length reduction in any one of the neural network layer processors 301, and constructs the feature encoder 70 such that, for the transformed input matrices 303, for example, the determination value has two possible values and the bit lengths at the two determination values are 4 and 8 and all the elements are allocated to the determination value of 1, while 32 elements are allocated to the determination value of 2 and, in each of the other neural network layer processors 301, the determination value has one possible value and the bit length at the one determination value is 16 and all the elements are allocated to the determination value of 1 (S21). The encoder constructor 80 uses the constructed feature encoder 70 to transform the input data 204 to the output data 205, measures the evaluation score (e.g., Recall at 1) of the output data 205, and performs the same processing by sequentially changing the neural network layer processor 301 to be subjected to the bit length reduction from one to another (S22). Then, the encoder constructor 80 determines that, for the feature encoder 70 having the evaluation score that has deteriorated by a predetermined threshold or higher from the evaluation score of the feature encoder which has not been reduced in bit length in any of the neural network layer processors 301, the bit length is not reduced in the neural network layer processor 301 that has been reduced in bit length in this feature encoder 70, i.e., a determination value is one and the bit length at the one determination value is 16 and all the elements are allocated to the determination value of 1. Meanwhile, for each of the other feature encoders 70, it is determined that, for the transformed input matrices 303, determination values are two and the bit lengths at the two determination values are 4 and 8 and all the elements are allocated to the determination value of 1, while 32 elements per row are allocated to the determination value of 2, for the matrix output from the activation processor 310, the bit length at the one determination value is 16 and all the elements are allocated to the determination value of 1, for the transformed weight matrices 304, a determination value is one and the bit length at the one determination value is 4 and all the elements are allocated to the determination value of 1 and, for the transformed activation parameters, a determination value is one and the bit length at the one determination value is 16 and all the elements are allocated to the determination value of 1 (S23). According to this processing, it is possible to reduce the bit length, the to-be-allocated element count, and the feature encoding processing time for the transformed input matrices 303 and make a determination to prevent an evaluation score reduction.

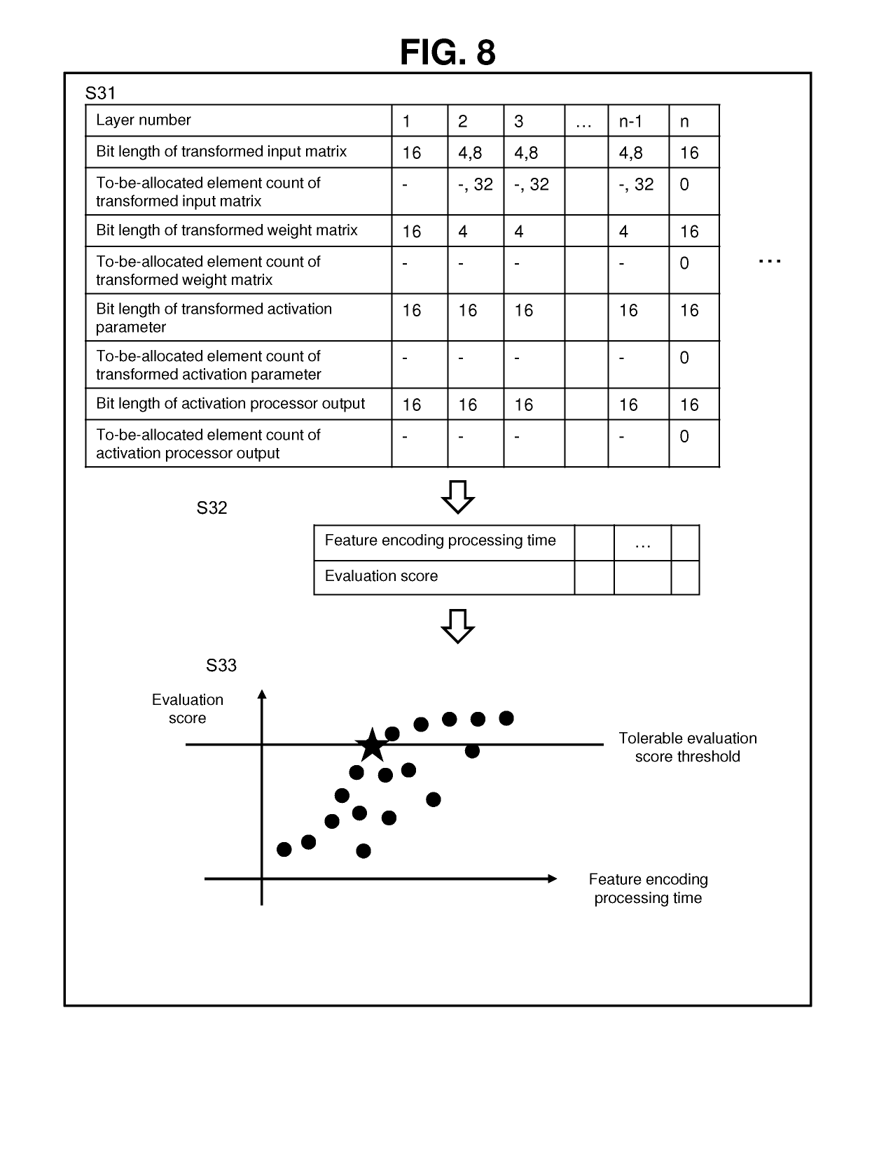

Moreover, in the bit length/to-be-allocated element count determination processing, as shown in, e.g., FIG. 8, the encoder constructor 80 constructs the feature encoder 70 for each of the transformed weight matrices 304, the transformed activation parameters 312, the transformed input matrices 303, and the matrix output from the activation processor 310 when a plurality of settings to be considered (which may also be all the settings that can be made) are made (S31), transforms the input data 204 to the output data 205 by using each of the constructed feature encoders 70, measures the evaluation score of the output data 205 and the time (feature encoding processing time) required for the feature encoding processing (S32), produces scatter plots of the measured evaluation score and feature encoding processing time, specifies the feature encoder 70 that has the evaluation score exceeding a tolerable evaluation score threshold and has implemented the shortest feature encoding processing time, and determines the bit length and the to-be-allocated element count in the feature encoder 70 to be the bit length and the to-be-allocated element count in the feature encoder 70 to be used for operation (S33). According to this processing, it is possible to appropriately determine the bit length and the to-be-allocated element count for each of the transformed weight matrices 304, the transformed activation parameters 312, the transformed input matrices 303, and the output from the activation processor so as to be able to obtain an appropriate evaluation score and reduce the feature encoding processing time.

Then, the encoder constructor 80 determines whether or not bit length transformation is required for either of the transformed weight matrices 304 and the transformed activation parameters 312 of the neural network layer processors 301 (S14). For example, when the weight matrix loaded in the model loading processing (S11) has a 16-bit length and each of the transformed weight matrices 304 determined in the bit length/to-be-allocated element count determination processing (S13) has a 4-bit length, the encoder constructor 80 determines that the bit length transformation is required, and determines that the bit length transformation is not required when it is determined that each of the transformed weight matrices 304 determined in the bit length/to-be-allocated element count determination processing (S13) has a 16-bit length.

As a result, when determining that the bit length transformation is required (S14: Y), the encoder constructor 80 performs the bit length transformation processing in order to obtain the transformed weight matrices 304 and/or the transformed activation parameters 312 having the transformed bit lengths (S15), and advances the processing to Step S16. Specifically, the encoder constructor 80 may also transform each of the elements of the weight matrices and/or the activation parameters loaded as the model to a closest integer value. The encoder constructor 80 may also construct the determination-type variable transformers 308, receive an input of the weight matrix and/or the activation parameter as the matrix 401, use the transformed input matrices 303 output from the determination-type variable transformers 308 as the bit length transformed weight matrices 304 and/or transformed activation parameters 312, and add the output activation matrices 311 to the transformed activation parameters 312.

Meanwhile, when it is determined that the bit length transformation is not required (S14: N), the weight matrices and the activation parameters each included when the model is loaded are used as the transformed weight matrices 304 and the transformed activation parameters 312, and the encoder constructor 80 advances the processing to Step S16.

In Step S16, the encoder constructor 80 performs processing of constructing the determination-type variable transformers 308, the matrix multiplication processor 309, and the activation processor 310 in the neural network layer processors 301. Specifically, when, e.g., it is determined in the bit length/to-be-allocated element count determination processing (S13) that the bit length is 16 for the transformed input matrices 303, the encoder constructor 80 may also construct the determinator 402 as a one-value function that outputs the determination value of 1 to each of elements and construct the variable transformers 403 such that identity transformation is performed thereby. Meanwhile, when, e.g., the bit lengths determined for the transformed input matrix 303 in the bit length/to-be-allocated element count determination processing (S13) are 4 (first bit) and 8 (second bit) and the to-be-allocated element count is determined to be 32, the encoder constructor 80 may also construct the determinator 402 as a two-value function that determines that each of the elements ranked in the top 32 in each row in terms of the absolute error from the per-row average value has the determination value of 2, construct the variable transformer 403-1 (first variable transformer), with a two-value function being determined as the determination value of 1 for each of elements, such that each of the elements of the determined matrix 404-1 (first matrix) is divided by a per-row absolute maximum value in the determined matrix 404-1, the resulting value is multiplied by 7 and then transformed to a closest integer value to have a 4-bit length (to be changed to the first bit), and construct the variable transformer 403-2 (second variable transformer) such that each of the elements of the determined matrix 404-2 (second matrix) is divided by a per-row absolute maximum value in the determined matrix 404-2, and the resulting value is multiplied by 127 and then transformed to a closest integral value to have a 8-bit length (changed to the second bit). By thus constructing all the neural network layer processors 301, the construction of the feature encoder 70 to be used during operation is completed.

Then, the encoder constructor 80 determines whether or not training of the feature encoder 70 is necessary (S17). Here, whether or not the training is necessary may be determined according to details of the setting made in advance, or it may also be possible to determine that the training is necessary when the input data 204 is transformed to the output data 205 by using the constructed feature encoder 70, the evaluation score of the output data 205 is measured, and the evaluation score has deteriorated by equal to or larger than the predetermined threshold.

As a result, when it is determined that the training is necessary (S17: Y), the encoder constructor 80 performs training processing (S18), and ends the feature encoder construction processing. In the training processing, for example, the encoder constructor 80 receives an input of the output data 205, defines an error function that outputs an error value, and changes respective values of the transformed weight matrices 304 and the transformed activation parameters 312 which are included in the respective neural network layer processors 301 so as to reduce the error value. In this case, the feature encoder 70 that uses the transformed weight matrix 304 and the transformed activation parameter 312 each changed by the training serves as the feature encoder 70 to be used in the subsequent operation.

Meanwhile, when it is determined that the training is unnecessary (S17: N), the constructed feature encoder 70 serves as the feature encoder 70 to be used in the operation, and therefore the encoder constructor 80 ends the feature encoder construction processing.

Note that the present invention is not limited to the embodiments described above, and can be modified appropriately to be carried out within the scope not departing from the gist of the present invention.

For example, in the embodiments described above, at least a portion of the processing performed by the processors 63 may also be performed by the processor 53.

Alternatively, in the embodiments described above, a part of or the entire processing performed by the processors may also be performed in a hardware circuit. The programs in the above embodiments may also be installed from a program source. The program source may be a program distribution server or a recording medium (e.g., a portable recording medium).

What is claimed is:

1. A feature encoding system encoding a feature of data, the feature encoding system comprising:
one or more neural network layer processors,
wherein at least one of the neural network layer processors includes:
a transformation processor configured to determine, for each of elements in an element group to be used for an operation, whether or not the element has a large effect on accuracy of the feature of the data on the basis of a value of the element, and transform, for a first element having a small effect on the accuracy of the feature, a value thereof to a value with a first bit length shorter than an original bit length, and also transform, for a second element having the large effect on the accuracy of the feature, a value thereof to a value with a second bit length longer than the first bit length; and
a matrix multiplication processor configured to perform a matrix multiplication operation by using the element group transformed by the transformation processor.

2. The feature encoding system according to claim 1,
wherein the transformation processor includes:
a determinator configured to determine whether each of the elements is the first element or the second element on the basis of the value of the element, and generate a first matrix including the first element and a second matrix based on a value of the second element;
a first variable transformer configured to transform a value of each of the elements of the first matrix to the value with the first bit length; and
a second variable transformer configured to transform a value based on each of elements of the second matrix to the value with the second bit length.

3. The feature encoding system according to claim 1,
wherein the number of the elements each determined to be the second element is a predetermined number or less of the elements in the element group.

4. The feature encoding system according to claim 2,
wherein the determinator includes:
a plurality of preliminary determinators configured to perform preliminary determination for determining, for each predetermined unit of the elements in the element group to be used for the operation, whether each of the elements is the first element or the second element; and
an integrator configured to integrate results of the determination by the plurality of preliminary determinators to determine whether or not each of the elements is the first element or the second element and generate the first matrix including the first element and the second matrix based on the value of the second element.

5. The feature encoding system according to claim 1, further comprising:
a plurality of memories,
wherein at least part of intermediate results in processing by the neural network layer processors is stored in one of the memories, which is most quickly accessible from the neural network layer processors, and used.

6. The feature encoding system according to claim 1,
wherein the element group to be used for the operation is at least one of the data and a matrix output from another neural network layer processor.

7. The feature encoding system according to claim 1, further comprising:
an activation processor configured to perform activation processing on a processing result from the matrix multiplication processor.

8. The feature encoding system according to claim 1, further comprising:
a main processor; and
a parallel processing device, wherein
the parallel processing device is configured to include a plurality of processors, and
each of the neural network layer processors is configured by one or more of the processors.

9. The feature encoding system according to claim 1, further comprising:
an encoder constructor configured to perform determination processing of changing the first bit length, the second bit length, and the number of the second elements in the transformation processor, calculating an evaluation score of the feature for predetermined data when the numbers are changed, determining the first bit length, the second bit length, and the number of the second elements during operation on the basis of the evaluation score, and constructing the transformation processor into a configuration having the determined first bit length, the determined second bit length, and the determined number of the second elements.

10. The feature encoding system according to claim 9,
wherein the plurality of neural network layer processors are provided,
wherein the plurality of neural network layer processors are configured to include respectively the transformation processors, and
wherein the encoder constructor is configured to perform the determination processing on the plurality of transformation processors.

11. The feature encoding system according to claim 10,
wherein the encoder constructor is configured to specify a processing time in the encoding of the feature for the predetermined data when the first bit length, the second bit length, and the number of the second elements in each of the transformation processors are changed in the determination processing, and determine the first bit length, the second bit length, and the number of the second elements during the operation on the basis of the evaluation score and the processing time.

12. A feature encoding method implemented by a feature encoding system that encodes a feature of data,
wherein the feature encoding system includes one or more neural network layer processors,
the method comprising, by at least one of the neural network layer processors, determining, for each of elements in an element group to be used for an arithmetic operation, whether or not the element has a large effect on accuracy of the feature of the data on the basis of a value of the element, and transforming, for a first element having a small effect on the accuracy of the feature, a value thereof to a value with a first bit length shorter than an original bit length, and also transforming, for a second element having the large effect on the accuracy of the feature, a value thereof to a value with a second bit length longer than the first bit length; and
performing a matrix multiplication operation by using the element group that has been transformed.

13. A feature encoding program for causing a feature encoding system to implement the feature encoding method according to claim 12.
